(19) United States
(12) Patent Application Publication
(10) Pub. No.: US 2010/0267123 A1
(43) Pub. Date: Oct. 21, 2010

(54) METHOD FOR CO2 TRANSFER FROM GAS STREAMS TO AMMONIA SOLUTIONS

(76) Inventor: Louis Wibberley, New South Wales (AU)

Correspondence Address: SUGHRUE MION, PLLC, 2100 PENNSYLVANIA AVENUE, N.W., SUITE 800, WASHINGTON, DC, 20037, US

(21) Appl. No.: 12/666,259

(22) PCT Filed: Jun. 23, 2008
(86) PCT No.: PCT/AU2008/000914

§ 371 Date: Jul. 8, 2010

(30) Foreign Application Priority Data
Jun. 22, 2007 (AU) 2007903368

(51) Int. Cl. B01D 53/62

(52) U.S. Cl. 435/266; 423/232; 423/233; 422/168

(57) ABSTRACT

A method of recovering carbon dioxide from a stream of flue gases, includes: contacting the stream at a gas pressure above atmospheric pressure with an aqueous solvent system, containing ammonium, carbonate and bicarbonate ions, at a temperature above 10° C. to effect absorption of CO₂ from the stream, and separating the solvent containing the absorbed CO₂ (as carbonate, bicarbonate and CO₂(aq)) from the stream of CO₂-leaner flue gases to form a CO₂ and/or bicarbonate-rich solvent stream. In a second aspect, the CO₂-leaner flue gases are cooled by contact with water that dissolves ammonia therefrom, and recycling said dissolved ammonia back to said solvent system. Apparatus is also disclosed.

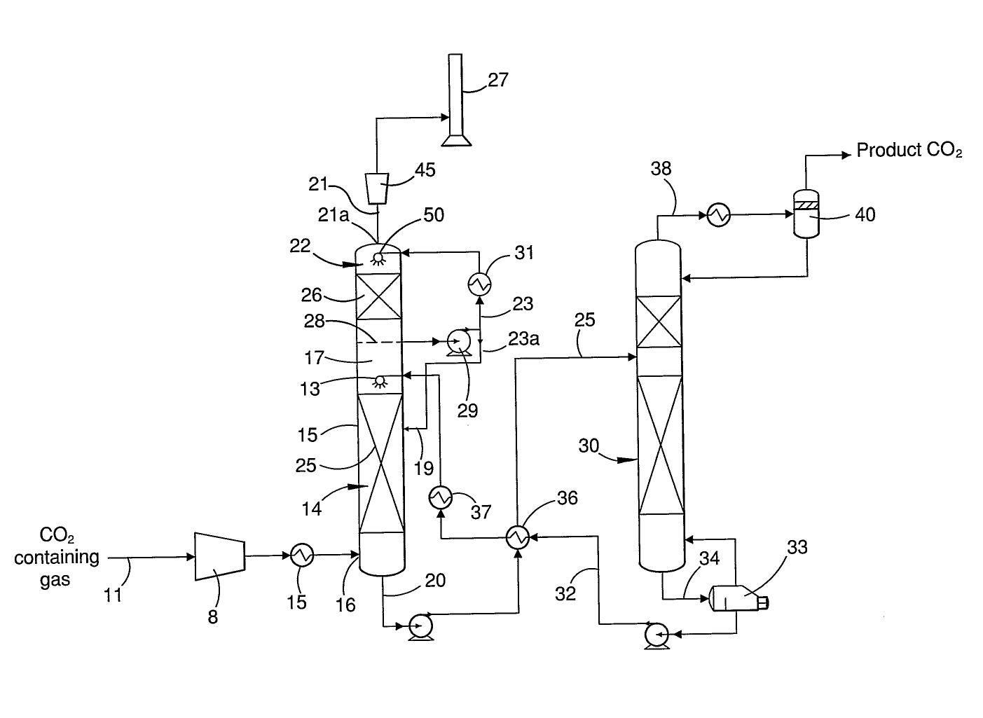

### FIELD OF THE INVENTION

This invention relates generally to the use of ammonia based solutions to absorb carbon dioxide from flue gases for the purpose of capturing carbon dioxide.

The invention has particular, though not of course exclusive, application to the post combustion capture of CO₂ from the flue gases of power stations or from process gases in a wide variety of industrial processes including steel plants, cement kilns, calciners and smelters.

### BACKGROUND OF THE INVENTION

There is rapidly growing pressure for stationary sources of CO₂ emissions such as power stations, to make step reductions in greenhouse gas emissions (GHG) through 1) capturing the CO₂ formed from the process, and 2) storing the CO₂ by various geological means. This involves injection of CO₂ in a supercritical or “liquefied” state into deep aquifers, coal seams, or deep ocean trenches in the ocean floor, or storage of CO₂ as solid compounds.

The process for capturing the CO₂ from power station or combustion device flue gases is termed post combustion capture. In post combustion capture, the CO₂ in flue gas is preferentially separated from nitrogen and residual oxygen using a suitable solvent in an absorber. The CO₂ is then removed from the solvent in a process called stripping (or regeneration), thus allowing the solvent to be reused. The stripped CO₂ is then liquefied by compression and cooling, with appropriate drying steps to prevent hydrate formation.

Post combustion capture in this form is applicable to a variety of stationary CO₂ sources as well as power stations, such as steel plants, cement kilns, calciners and smelters.

The main disadvantage of this process is that the CO₂ partial pressure is relatively low, which necessitates the use of CO₂-selective solvents, the addition of promoters, cooling for the absorption process, and a large gas-liquid contact area to enable sufficient solvent loading.

The use of solutions of ammonia for removing CO₂ from flue gas streams is attractive from a chemistry perspective, with a number of important advantages relative to systems that employ monoethanolamine (MEA) or other amines as the solvent, long-known for recovering CO₂ from gas mixtures:
SOx and NOx can be absorbed, with the possibility of advantageously selling the spent solvent solution as a fertiliser (SOx and NOx degrade amine solvents).
Ammonia is a low cost chemical, in widespread commercial use.
Oxygen in the flue gas does not degrade the solvent (but it does degrade amines).

The overall energy required for such a process is projected to be around 40% of that required for MEA systems.

For the ammonia process, the solvent solution consists of ammonium, carbonate and bicarbonate ions, in equilibrium with dissolved ammonia (aqueous), and dissolved CO₂ (aqueous). In the absorber, water and ammonia react with CO₂ (aqueous) to form bicarbonate ions or ammonium carbamate ions, with the reaction reversed in the stripper by the application of energy. The relevant aqueous phase reactions can be summarized by the following overall equations:

CO₂+H₂O+NH₃ [symbol] HCO₃⁻+NH₄⁺ (eqn. 1)

CO₂+2NH₃ [symbol] NH₂COO⁻+NH₄⁺ (eqn. 2)

HCO₃⁻+NH₃ [symbol] CO₃²⁻+NH₄⁺ (eqn. 3)

CO₃²⁻+H₂O+CO₂ [symbol] 2HCO₃⁻ (eqn. 4)

The amount of free ammonia in the gas phase exiting the absorber is proportional to the amount of ammonia (aqueous), which is controlled by the concentration of the other species in the solution, and the temperature: higher temperatures increase the amount of ammonia in the gas phase.

The major concern with the ammonia process has been ammonia loss (or “slip”) associated with both the absorber and the stripper.

International patent publication WO 2006/022885 proposes to address the problem of ammonia slip by cooling the flue gas to 0-20° C. and operating the absorption stage in this temperature range, preferably in the range 0-10° C.

Regeneration is by elevating the pressure and temperature of the CO₂-rich solution from the absorber. The CO₂ vapour pressure is high, and a pressurized CO₂ stream, with low concentration of NH₃ and water vapour, is generated. The high pressure CO₂ stream is cooled and washed to recover the ammonia and moisture from the gas. This process, known as a chilled ammonia process, is reported to reduce the degree of ammonia slip, but requires considerable energy for chilling, particularly when it is considered that the reaction heat (the carbonate to bicarbonate reaction involved is exothermic) must be removed to maintain the low temperature. This cooling requirement renders the chilled ammonia process impractical on a larger scale in warmer or even temperate climates. Low temperatures also reduce the kinetics of the absorption reaction.

It is an object of the invention to address the issue of ammonia slip in ammonia-based systems for removing CO₂ from flue gases, while maintaining a satisfactory temperature for CO₂ absorption.

### SUMMARY OF INVENTION

In the present invention, a higher absorption temperature is proposed (e.g. around 20-30° C.), to increase the reaction kinetics through the effect of temperature on the activation energy for the reaction. For this benefit to be achieved, it is necessary to incorporate at least one of the following additional measures:

1. absorption of CO₂ from the flue gas under pressure; and/or

2. cooling of the gas exiting the absorber, e.g. by chilled water washing.

Absorption under pressure, in addition to reducing the partial pressure of ammonia in the gas phase (ie ammonia “slip”) also increases the amount of CO₂ (aqueous) in solution, according to Henry's Law. This has a beneficial impact on the rate of formation of bicarbonate.

Chilled water washing can be employed at any desired temperature down to the freezing point. This approach is advantageous compared to chilling the overall solution in the absorber, as in WO 2006/022885, since there is less chilling required due to the smaller amount of gas, and since the need to remove the reaction heat, at the lower absorber temperature, is avoided.

The invention accordingly provides, in a first aspect, a method of recovering carbon dioxide from a stream of flue gases, comprising:
contacting the stream at a gas pressure above atmospheric pressure with an aqueous solvent system, containing ammonium, carbonate and bicarbonate ions, at a temperature above 10° C. to effect absorption of CO₂ from the stream, and
separating the solvent containing the absorbed CO₂ (as carbonate, bicarbonate and CO_{2(aq)}) from the stream of CO₂-leaner flue gases to form a CO₂ and/or bicarbonate-rich solvent stream.

The stream of flue gases is preferably at a gas pressure in the range 100-3000 kPa, (1 to 30 bar), most preferably in the range 500-1500 kPa (5 to 15 bar), when contacted with the solvent system. To achieve this, the stream of flue gases is preferably compressed to the desired pressure before said contact.

Absorption of the CO₂ may typically be according to equations (1) to (4) above.

In a second aspect, the invention produces a method of recovering carbon dioxide from a stream of flue gases, comprising the steps according to the first aspect, as well as the following additional step:
cooling said CO₂-leaner flue gases by contact with water that dissolves ammonia therefrom, and recycling the dissolved ammonia back to said solvent system.

Typically in either aspect, the method includes the further steps of desorbing CO₂ from the CO₂-rich solvent stream by application of heat to the solvent stream to desorb the CO₂. The now CO₂-lean solvent stream may be conveniently recycled to said solvent system. Typically, CO₂ desorbed from the CO₂-rich solvent stream is compressed, cooled and liquefied for storage.

The invention also provides, in its second aspect, a method of recovering carbon dioxide from a stream of flue gases, comprising:

contacting the stream with an aqueous solvent system, containing ammonium, carbonate and bicarbonate ions, at a temperature above 10° C. to effect absorption of CO₂ from the stream;

separating the solvent containing the absorbed CO₂ (as carbonate, bicarbonate and CO_{2(aq)}) from the stream of CO₂-leaner flue gases to form a CO₂ and/or bicarbonate-rich solvent stream; and

cooling said CO₂-leaner flue gases by contact with water that dissolves ammonia therefrom, and recycling said dissolved ammonia back to said solvent system.

In the second aspect, the invention further provides apparatus for recovering carbon dioxide from a stream of flue gases, comprising:
an absorber stage for contacting the stream with an aqueous solvent system at a temperature above 10° C. and containing dissolved ammonia to effect absorption of CO₂ from said stream, and for separating the solvent containing the absorbed CO₂ from the stream of CO₂-leaner flue gases to form a CO₂ and/or bicarbonate-rich solvent stream; and
means for cooling said CO₂-leaner flue gases by contact with water that dissolves ammonia therefrom and for recycling the dissolved ammonia back to said solvent system.
   For either the first or second aspect:
the temperature of the aqueous solvent system is preferably greater than 15° C., more preferably greater than 20° C., and most preferably in the range 20-50° C. A temperature in the range 25° to 45° is suitable.
If required, the stream of flue gases is cooled before being contacted with the solvent system, for example to about 40° C.

Advantageously, the steps of contacting the stream of flue gases with the aqueous solvent system and cooling the CO₂-leaner flue gases are carried out in a common vessel, e.g. a tower vessel, in which the gas pressure is above atmospheric. This pressure is preferably in the range 100 to 3000 kPa (1 to 30 bar), most preferably in the range 500-1500 kPa (5 to 15 bar).

Advantageously, after said cooling step, the cooled CO₂-leaner flue gases at a pressure above atmospheric are further cooled by being expanded to a lower pressure, for example to substantially atmospheric pressure, resulting in further condensation of residual ammonia which is recycled to the aqueous solvent system.

Advantageously, said absorption of CO₂ is catalysed by the presence of selected enzymes to promote the rate of absorption of CO₂ to bicarbonate in solution. A suitable such enzyme is carbonic anhydrase.

An alternative to using enzymes to promote the rate of CO₂ conversion to bicarbonate in solution is the use of inorganic Lewis bases, such as arsenate (AsO₄³⁻) or phosphate (PO₄³⁻). The enzyme or Lewis base (promoters) can be circulated at low concentration in the liquid solvent or supported on solid structures over which the solvent solution and CO₂ containing gases flow. In the latter case, the surface of the support material has been chemically modified, so that the enzymes or Lewis base attach securely, and is configured to maximise gas-liquid transfer of CO₂.

With the solid support option, the type and configuration of the enzyme or Lewis base, and its support, can be varied to accommodate variations in the composition of the CO₂ containing gas, the local loading of the solvent, and local temperature and pressure conditions.

### DESCRIPTION OF EMBODIMENTS OF THE INVENTION

The invention will now be further described, by way of example only, with reference to the accompanying diagram of post-combustion capture plant in accordance with a preferred embodiment of both aspects of the invention.

CO₂-lean solvent solution is pumped and sprayed in at the top 13 of an absorber stage in the form of a packing column 14 in the lower part of a towel vessel 15. This solution flows around and downwardly through packing material 25 of the column 14, while the CO₂ containing stream of flue gases 11 is compressed by compression plant 8, thereafter cooled at 15 (to, for example, about 40° C.), and then introduced at 16 to the bottom of the absorber. The compressed and cooled flue gases pass up through the packing material and thereby contact the solvent system comprising the solvent solution flowing down the packing material. CO₂ is transferred to the solvent solution, a process that is preferably enhanced by the interaction with appropriate added enzymes or a Lewis base.

Compressor plant 8 may comprise a gas turbine compressor which is suitable for compressing relatively high volumes of gas up to 30 bar. In this case, it is thought that a gas pressure of about 10 bar in column 14 will achieve satisfactory results.

The presence of a base such as ammonia/ammonium ions maintains a basic absorber solution pH to keep the dissolved CO₂ as HCO₃⁻/CO₃²⁻ ions. Ammonia can also directly react with dissolved CO₂ to form carbamates. At sufficiently high concentrations, the bicarbonate/carbonate ions can also precipitate out of solution as the ammonium salts, resulting in a slurry, which allows more CO₂ to be transferred by the loaded solvent system.

At the top 17 of the absorber column 14, the CO₂-leaner gases leave the process, while the CO₂-rich solution 25 (containing, carbamate, carbonate and bicarbonate) is extracted from the bottom at 20 for further processing. Ammonia slip is ameliorated by subjecting the exit gas before it is passed to a flue stack 27, to a cold water wash from overhead sprays 50 in the upper part of the tower vessel 15. A further small column 26 of suitable packing material facilitates contact and therefore the cooling process. The cold water, e.g. at 0-10° C., dissolves ammonia from the CO₂-leaner flue gases, and is collected in a tray system 28 for recirculation by a pump 29 via a cooling device 31. A proportion of the recirculating ammonia-loaded wash water 23 is recycled via conduit 23a to the solvent system in the absorber stage at 19.

The cooled CO₂-leaner gases 21 exiting the tower vessel 15 at 21a, are at the gas pressure within the vessel (suitably about 10 bar, as noted earlier). Preferably, these gases are expanded in a chamber 45, in a controlled manner whereby further cooling of the gases is achieved and further residual ammonia condenses from the gases and is recycled to the solvent solution.

The bicarbonate-rich solvent solution is delivered via line 25 to be heated in a stripper or absorbent regeneration stage, in this case a packing column 30, to release the CO₂ for storage or other chemical applications, with the recovered CO₂ lean solvent solution 34 being re-circulated via reboiler 33 and conduit 32 back to the top 13 of the absorber column 14: it is cooled en route as necessary by heat exchange at 36 with the CO₂-rich solvent stream in line 25, and by a second cooler 37. The process also allows utilization of carbonate and bicarbonate salts such as ammonium carbonate/bicarbonate if desired. The recovered CO₂ stream 38 is typically treated at 40 by being compressed, cooled and liquefied for storage.

The stripper/regeneration stage is preferably also operated at a gas pressure above atmospheric, for example a pressure similar to that maintained in the absorber stage, around 10 bar.

It will of course be appreciated that columns 14, 30 may each comprise more than one absorber or stripper. Moreover, within an individual column 14, 26 or 30, there may well be multiple stages.

1. A method of recovering carbon dioxide from a stream of flue gases, comprising:
contacting the stream at a gas pressure above atmospheric pressure with an aqueous solvent system, containing ammonium, carbonate and bicarbonate ions, at a temperature above 10° C. to effect absorption of CO₂ from the stream,
separating the solvent containing the absorbed CO₂ (as carbonate, bicarbonate and CO_{2(aq)}) from the stream of CO₂-leaner flue gases to form a CO₂ and/or bicarbonate-rich solvent stream; and
expanding the CO₂-leaner flue gases to a lower pressure thereby cooling the gases.

2. A method according to claim 1 wherein said gas pressure is in the range 100-3000 kPa, when contacted with the solvent system.

3. A method according to claim 1 wherein said gas pressure is in the range 500-1500 kPa, when contacted with the solvent system.

4. A method according to claim 1 further including compressing said stream of flue gases prior to said contacting step, to said gas pressure above atmospheric pressure.

5. A method according to claim 31 further including
cooling said CO₂-leaner flue gases by contact with water that dissolves ammonia therefrom, and recycling said dissolved ammonia back to said solvent system.

6. A method according to claim 33 wherein the steps of contacting the stream of flue gases with the aqueous solvent system and cooling the CO₂-leaner flue gases by contact with water are carried out in a common vessel.

7. (canceled)

8. A method according to claim 1 wherein said contacting step is effected at a temperature greater than 20° C.

9. A method according to claim 1 wherein said contacting step is effected at a temperature in the range 20-50° C.

10. A method according to claim 1, further including desorbing CO₂ from the CO₂ and/or bicarbonate-rich solvent stream by application of heat to the solvent stream to desorb the CO₂, and thereby form a CO₂-lean solvent stream, and recycling the CO₂-lean solvent stream to said solvent system.

11. A method according to claim 10 wherein said CO₂ desorbed from the CO₂ and/or bicarbonate-rich solvent stream is compressed, cooled and liquefied for storage.

12. A method according to claim 1, including cooling the stream of flue gases before it is contacted with the solvent stream.

13. A method according to claim 1 wherein said absorption of CO₂ is catalysed by the presence of selected enzymes to promote the rate of absorption of CO₂ to bicarbonate in solution.

14. A method according to claim 1 wherein said absorption of CO₂ is promoted by the addition of inorganic Lewis bases.

15. A method of recovering carbon dioxide from a stream of flue gases, comprising:
contacting the stream with an aqueous solvent system, containing ammonium, carbonate and bicarbonate ions, at a temperature above 10° C. to effect absorption of CO₂ from the stream;
separating the solvent containing the absorbed CO₂ (as carbonate, bicarbonate and CO_{2(aq)}) from the stream of CO₂-leaner flue gases to form a CO₂ and/or bicarbonate-rich solvent stream; and
cooling said CO₂-leaner flue gases by contact with water that dissolves ammonia therefrom, and recycling said dissolved ammonia back to said solvent system.

16. A method according to claim 15 wherein the steps of contacting the stream of flue gases with the aqueous solvent system and cooling the CO₂-leaner flue gases are carried out in a common vessel.

17. A method according to claim 15 wherein, after said cooling step, the cooled CO₂-leaner flue gases at a pressure above atmospheric are further cooled by being expanded to a lower pressure, for example to substantially atmospheric pressure, resulting in further condensation of residual ammonia which is recycled to the aqueous solvent system.

18.-24. (canceled)

25. Apparatus for recovering carbon dioxide from a stream of flue gases, comprising:
an absorber stage for contacting the stream with an aqueous solvent system at a temperature above 10° C. and containing dissolved ammonia to effect absorption of CO₂ from said stream, and for separating the solvent containing the absorbed CO₂ from the stream of CO₂-leaner flue gases to form a CO₂ and/or bicarbonate-rich solvent stream; and
a gas expander mounted to receive said CO₂-leaner gases and to expand the gases to a lower pressure.

26. Apparatus according to claim 25 further including a compressor arranged to compress said stream of flue gases to a pressure greater than atmospheric pressure, and connected to said absorber stage to deliver the pressurized gases thereto for said contacting with the aqueous solvent system, whereby in operation said contacting is effected at a pressure above atmospheric pressure.

27. Apparatus according to claim 38 wherein said absorber stage and said arrangement for cooling are provided by a common vessel.

28. (canceled)

29. Apparatus according to claim 25, further including a stripper stage connected to receive the CO₂ and/or bicarbonate-rich solvent stream from the absorber stage and to apply heat to desorb CO₂ from the stream and thereby form a CO₂-lean solvent stream, which stripper stage is further connected to recycle the CO₂-lean solvent stream to said solvent system.

30. Apparatus according to claim 25, further including a device to cool the stream of flue gases before it is contacted with the solvent system.

31. A method according to claim 1 further including recycling to the aqueous solvent system ammonia condensed from said flue gas as a result of said expansion.

32. A method according to claim 1 wherein said lower pressure is substantially atmospheric pressure.

33. A method according to claim 5 wherein said cooling by contact with water is effected prior to said expanding to a lower pressure.

34. A method according to claim 3 wherein said contacting step is effected at a temperature greater than 20° C.

35. A method of recovering carbon dioxide from a stream of flue gases, comprising:
contacting the stream at a gas pressure above atmospheric pressure with an aqueous solvent system, containing ammonium, carbonate and bicarbonate ions, at a temperature above 10° C. to effect absorption of CO₂ from the stream, and
separating the solvent containing the absorbed CO₂ (as carbonate, bicarbonate and CO_{2(aq)}) from the stream of CO₂-leaner flue gases to form a CO₂ and/or bicarbonate-rich solvent stream.

36. A method according to claim 35 wherein said gas pressure is in the range 500-1500 kPa, when contacted with the solvent system.

37. A method according to any one of claim 36 wherein said contacting step is effected at a temperature in the range 20-50° C.

38. Apparatus according to claim 25 further comprising an arrangement for cooling said CO₂-leaner flue gases by contact with water that dissolves ammonia therefrom, and for recycling the dissolved ammonia back to said solvent system.

39. Apparatus according to claim 25 wherein said gas expander is configured and connected to recycle to the aqueous solvent system ammonia condenses from said flue gas as a result of said expansion.
